(19) United States
(12) Patent Application Publication
(10) Pub. No.: US 2026/0257757 A1
(43) Pub. Date: Sep. 3, 2026

(54) MICROMOBILITY DEVICE CONTROL MODES

(71) Applicant: Also, Inc., Palo Alto, CA (US)

(72) Inventors: Jonathan Louis HALL, Menlo Park, CA (US); Christopher YU, Menlo Park, CA (US); Robert Saul LEIKEN, San Francisco, CA (US)

(73) Assignee: Also, Inc., Palo Alto, CA (US)

(21) Appl. No.: 19/554,050

(22) Filed: Mar. 2, 2026

Related U.S. Application Data
(60) Provisional application No. 63/765,880, filed on Mar. 3, 2025.

(51) Int. Cl. B62M 6/45; B62H 5/20

(52) U.S. Cl. CPC B62M 6/45; B62H 5/20

(57) ABSTRACT

A micromobility device can include a propulsion system and a control system communicably coupled to the propulsion system. The control system can detect a user device within a threshold distance of the micromobility device, determine, based on the user device, an operating mode of the propulsion system, receive, via a throttle, a user input to the throttle, modify a signal associated with the user input to the throttle based on the operating mode, and cause the propulsion system to adjust an operating condition of the propulsion system based on the modified signal.

### CROSS-REFERENCE TO RELATED PATENT APPLICATIONS

This application claims the benefit of and priority to U.S. Provisional Patent Application No. 63/765,880, filed on Mar. 3, 2025, the entire disclosure of which is incorporated by reference herein.

### BACKGROUND

Bicycles can include various hardware and software that control operation of the bicycle.

### SUMMARY

At least one aspect is directed to a micromobility device. The micromobility device can include a propulsion system and a control system communicably coupled to the propulsion system. The control system can detect a user device within a threshold distance of the micromobility device, determine, based on the user device, an operating mode of the propulsion system, receive, via a throttle, a user input to the throttle, modify a signal associated with the user input to the throttle based on the operating mode, and cause the propulsion system to adjust an operating condition of the propulsion system based on the modified signal.

At least one aspect is directed to a control system of a micromobility device. The control system can include one or more processors. The one or more processors can detect a user device within a threshold distance of the micromobility device, determine, based on the user device, an operating mode of a propulsion system of the micromobility device, receive, via a throttle of the micromobility device, a user input to the throttle, modify a signal associated with the user input to the throttle based on the operating mode, and cause the propulsion system to adjust an operating condition of the propulsion system based on the modified signal.

At least one aspect is directed to a method. The method can include detecting, by a control system of a micromobility device, a user device within a threshold distance of the micromobility device. The method can include determining, by the control system, based on the user device, an operating mode of a propulsion system of the micromobility device. The method can include receiving, by the control system, via a throttle of the micromobility device, a user input to the throttle. The method can include modifying, by the control system, a signal associated with the user input to the throttle based on the operating mode. The method can include causing, by the control system the propulsion system to adjust an operating condition of the propulsion system based on the modified signal.

At least one aspect is directed to a micromobility device. The micromobility device can include a propulsion system and a control system communicably coupled with the propulsion system. The control system can determine, via an onboard sensor, a location of the micromobility device, compare the location to a region having device limitations, determine a corresponding operating condition of the propulsion system associated with the device limitations, and apply the corresponding operating condition to the propulsion system while the micromobility device is within the region.

At least one aspect is directed to a control system of a micromobility device. The control system can include one or more processors. The one or more processors can determine, via an onboard sensor of the micromobility device, a location of the micromobility device, compare the location to a region having device limitations, determine a corresponding operating condition of a propulsion system of the micromobility device associated with the device limitations, and apply the corresponding operating condition to the propulsion system while the micromobility device is within the region.

At least one aspect is directed to a method. The method can include determining, by a control system of a micromobility device, a location of the micromobility device. The method can include comparing, by the control system, the location to a region having device limitations. The method can include determining, by the control system, a corresponding operating condition of a propulsion system of the micromobility device associated with the device limitations. The method can include applying, by the control system, the corresponding operating condition to the propulsion system while the micromobility device is within the region.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example schematic of a bicycle system, in accordance with some aspects.

FIG. 2 depicts an example schematic of a bicycle system, in accordance with some aspects.

FIG. 3 depicts an example schematic of a bicycle system, in accordance with some aspects.

FIG. 4 is a block diagram illustrating an architecture for a computer system that can be employed to implement elements of the systems and methods described and illustrated herein.

FIG. 5 is an example illustration of a method, in accordance with some aspects.

FIG. 6 is an example illustration of a method, in accordance with some aspects.

### DETAILED DESCRIPTION

Following below are more detailed descriptions of various concepts related to, and implementations of, methods, apparatuses, and systems of defining, generating, regulating, and implementing modes of operations of a micromobility device, such as an electric bicycle. The various concepts introduced above and discussed in greater detail below may be implemented in any of numerous ways.

The technical solutions described herein are generally directed to a control system capable of generating and implementing various modes of operation of a micromobility device, such as bicycle. The control system can, for example, receive a predefined mode of operation for a specified user and can implement the mode of operation responsive to detecting the user (e.g., via a user device or input to a display of the bike or through various other ways). The control system can, for example, detect a location of the bike and determine, based on the location, a desired operating condition of the bike. The control system can display or implement the desired operating condition of the bike. The control system can, for example, cause an external indicator of a bike to render a detectable feature based on the control system detecting or changing a mode of operation of the bike.

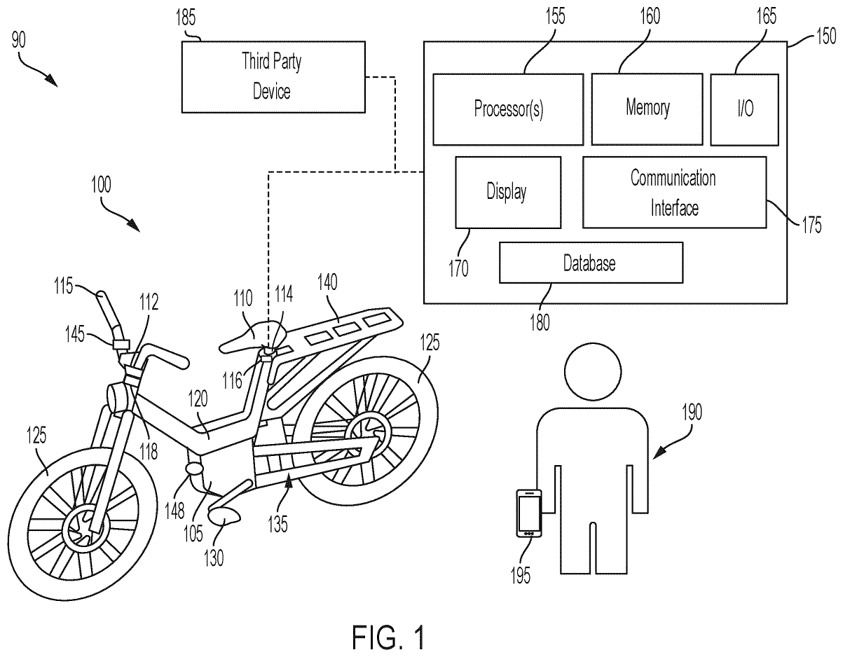

FIG. 1 depicts an example schematic of a system 90, according to an example implementation. The system 90 can include, for example, a bicycle system 90. The system 90 can include a micromobility device 100. The micromobility device 100 can be or can include a bicycle, electric bicycle, (e.g., bike) or other mobility device or apparatus. For example, for ease of description the micromobility device 100 can be referred to herein and interchangeably as “bicycle” or “bike,” and can use of these terms can include or encompass other micromobility devices, including, but not limited to, scooters, hoverboards, skateboards, personal transport devices, or other devices that can move one or more than one person. The bike 100 can be or include an electric bike 100 (e.g., e-bike) installed with at least one battery pack 105. The bicycle 100 can be a human-operated bike 100. The bike 100 can include single rider bicycles, tandem bicycles, cargo bicycles, motor-assist bicycles, pedicabs, electric-assist bicycles, road bicycles, mountain bicycles, or unicycles, among others. The battery pack 105 can be used as an energy storage system to power a building, such as a residential home or commercial building. The bike 100 can be fully electric or partially electric (e.g., pedal-powered) and further, the electric bike 100 can be fully autonomous, partially autonomous, semi-autonomous, or unmanned. The electric bike 100 can be human operated or non-autonomous. A human operator or the rider (e.g., user 190) of the bike 100 can sit on a seat 110 (e.g., saddle) to operate the bike 100. The rider of the bike 100 can steer, grip, balance, or otherwise control the bike 100 using a handlebar 115.

The bike or other micromobility device 100 can include a frame 120. The frame 120 can support various components of the bike 100, such as the handlebar 115, the seat 110, and the battery 105. The bike 100 can include one, two, or more wheels 125 (e.g., a front wheel and a rear wheel). The bike 100 can include at least one pedal 130 for the user 190 of the bike 100 to drive the bike 100 via force on the pedal 130 by, for example, the user's foot. The bike 100 may include no pedals 130. The frame 120 can include or can couple with a drive train 135 of the bike 100, a rack 140 of the bike 100 (e.g., carrier), a propulsion system 148, or additional or alternative components. The battery 105 can be disposed or coupled to anywhere on the frame 120. The drive train 135 can include or can couple to, but is not limited to, propulsion components including a motor (e.g., the propulsion system 148 described herein), a chain or belt, a throttle 145, gears, a controller, sensors, a batter management system (BMS), or the battery 105.

The bike or other micromobility device 100 can include at least one battery 105 or battery pack 105 that can include at least one battery, at least one battery module, or at least one battery cell. The battery 105 can electrically couple with the bike 100 (e.g., to the drive train 135, to the propulsion system 148, or other components). For example, the battery 105 can provide electrical energy to the bike 100 to power the bike 100. The battery 105 can be installed or placed within the bike 100. For example, the battery 105 can be installed on the frame 120 of the bike 100. The battery 105 can be integrally coupled with the frame 120 such that it is not removable. The battery 105 can be detachably coupled with the frame 120 such that in can be removed (e.g., to charge the battery 105).

The bike or other micromobility device 100 can include at least one throttle 145. The throttle 145 can include or can be a thumb throttle, a twist throttle, a push-button throttle, or another type of throttle capable of receiving a user input to command a motor or provide propulsion for the bike 100 (e.g., via a propulsion system 148 or drive train 135 described herein). For example, the throttle 145 can receive a user input (e.g., pressing, turning, twisting, or another input). Responsive to receiving the input, the throttle 145 can communicate with the propulsion system 148 to cause a motor or other components of the propulsion system 148 to activate to cause the bike 100 to move. The throttle 145 can couple to or be located on the handlebar 115. The throttle 145 can alternatively or additionally couple to or be located on various other components of the bike 100 including, but not limited to, the seat 110, the frame 120, or the drive train 135. As described herein, one or more components of the throttle 145, such as communication between the throttle 145 and the propulsion system 148, can change, update, or be modified based on an operational status of the bike 100.

The bike or other micromobility device 100 can include at least one propulsion system 148. The propulsion system 148 can include one or more electrical, mechanical, or electromechanical components that generate and deliver motive power to the bike 100. For example, the propulsion system 148 can include at least one motor. The one or more motors can be disposed or coupled to one or more of the wheels 125 of the bike 100 (e.g., integrated into a wheel hub). The one or more motors can be disposed or coupled to a bottom bracket or crank area (e.g., at or near the drive train 135 or the battery 105). Alternatively or additionally, the one or more motors can be disposed or coupled to a different portion of the bike 100. The propulsion system 148 can include additional components to facilitate controlling or driving the bike 100 or motors. For example, the propulsion system 148 can include one or more batteries (e.g., the battery 105 or additional/alternative batteries), one or more inverters, one or more processors or memory (e.g., controller), one or more power transmission components (e.g., one or more portions of the drive train 135), or one or more sensors.

The propulsion system 148 can communicably couple to the throttle 145. For example, the throttle 145 can generate an input signal that corresponds to a propulsion request (e.g., responsive to receiving a user input). The propulsion system 148 can receive the request and determine, based on the request, a target torque, target power level, or other operational level of the motor or other components of the propulsion system 148. Based on the request, the propulsion system 148 (e.g., via a controller) can determine or adjust one or more system constraints of the bike 100 including, but not limited to, speed limit, acceleration limit, throttle limit, current limit, thermal limits, brake conditions, or other constraints. The propulsion system 148 (e.g., via a controller) can communicate back to the throttle 145 to change, update, modify, cut off, or adjust the signals of the throttle 145 to adjust to the system constraints. The propulsion system 148 can communicably couple to a control system 150, as described herein.

The bike or other micromobility device 100 can include at least one control system 150. The control system 150 can be or can include a computer system (e.g., computer system 400 described herein) including various software or hardware to facilitate controlling one or more features of the bike 100. For example, the control system 150 can include one or more processor(s) 155. The processor 155 can be or can include the features of the processor 410 described herein. The control system 150 can include at least one memory 160. The memory 160 can be or can include features of the memory 415 or read only memory (ROM) 420 described herein. The control system 150 can include at least one input/output device 165. The input/output device 165 can be or can include features of the input device 430 described herein. The control system 150 can include at least one display 170. The display 170 can be or can include features of the display 435 described herein. The control system 150 can include at least one database 180. The database 180 can be or can include one or more features of the storage device 425 described herein. For example, the database 180 can store various information, as described herein. The control system 150 can include at least one communication interface 175.

The communication interface 175 can include various hardware or software to facilitate communication between the control system 150 and various other components including, but not limited to, at least one user device 195, third party device 185, another bike 100 (e.g., via a second communication interface 175), or server. For example, the communication interface 175 can include one or more wired or wireless components including network interfaces, antennas, global positioning systems (GPS, GLONASS, Galileo, BeiDou/BDS, QZSS), communication links, communication channels, or other communication devices. The control system 150 can couple with the bike 100 to control or regulate various properties of the bike 100 including, but not limited to, the battery 105, the drive train 135, the throttle 145, the propulsion system 148, the pedals 130, or various other portions of the bike 100. The bike 100 can include one or more onboard sensors, including, but not limited to, location sensors (e.g., that are configured to receive location data via the global positioning system), wheel speed sensors, cadence sensors, among other sensors.

The user device 195 can be or can include one or more devices associated with the user 190 of the bike 100, or another user (e.g., someone not necessarily operating the bike 100). For example, the system 90 can include a plurality of user devices 195. The user device 195 can be or can include a cellular device (e.g., a smart phone), a watch (e.g., a smart watch with or without cellular capabilities), a ring (e.g., smart ring), a laptop, or various other personal devices having one or more communication interfaces capable of communicating with the communication interface 175 of the control system 150. For example, the user device 195 can communicate with the control system 150 (e.g., via the communication interface 175) through near field communication (NFC), Bluetooth, radio-frequency identification (RFID), cellular communication, or other communication means. The user device 195 can communicate with the control system 150 through one or more networks or protocols including, but not limited to, wide area networks (WAN), local area networks (LAN), wireless networks (e.g., Wi-Fi), or various other networks. For example, the control system 150 of the bike 100 can include LTE, 4G, or 5G capabilities, or other network capabilities.

The control system 150 can implement a mode of operation responsive to the bike 100 exchanging or receiving a component of the bike 100. For example, one or more portions of the bike 100 (e.g., the frame 120) can include an electrical or mechanical connector that can receive a replaceable component of the bike 100, such as a replaceable seat 110, a replaceable handlebar 115, or other various components. For example, the seat 110, the handlebar 115, or another component can include a connector (e.g., a handlebar connector 112 and a seat connector 114) that can connect with a corresponding connector (e.g., a first frame connector 116 and a second frame connector 118) of the frame 120 to physically and communicably couple the replaceable seat 110 or handlebar 115 with the bike 100 and the control system 150.

For example, the seat 110 can include identification circuitry such as a memory device (e.g., EPROM, EEPROM, or other storage medium), a microcontroller, or other data storage mechanism configured to store a unique identifier (UID, RFID) or data indicative of the type or configuration of the seat 110. For example, the UID or data can indicate that the seat 110 is a standard seat configuration, a child-sized seat configuration, a sport seat configuration, or a relaxed seat configuration, among other types of configurations.

The UID or data can include an associated user profile. For example, a first user profile can be associated with a first seat configuration and a second user profile can be associated with a second seat configuration. The first user profile can be stored within the data storage mechanism of a standard seat configuration. The second user profile can be stored within the data storage mechanism of a sport seat configuration. Additionally or alternatively, the UID can encode the user's settings associated with the seat 110 or bike 100 (e.g., the UID can include embedded information about the seat 110 or a user associated with the seat 110). The connector 114 of the seat 110 can receive and transmit such data to the control system 150, or another portion of the bike 100, via the first connector 116 of the frame 120. For example, upon the seat connector 114 coupling with the first frame connector 116, the control system 150 can detect the identity and characteristics of the seat 110, which can be used to select or load a specific operating profile for the associated user. For example, the user profile can be associated with the user device 195 or with the user 190 having a predefined operating mode, as described herein.

Similarly, the handlebar 115 can include identification circuitry such as a memory device (e.g., EPROM, EEPROM, or other storage medium), a microcontroller, or other data storage mechanism configured to store a unique identifier (UID, RFID) or data indicative of the type or configuration of the handlebar 115. For example, the UID or data can indicate that the handlebar 115 is a standard handlebar configuration, a child-sized handlebar configuration, a sport handlebar configuration, or a relaxed handlebar configuration, among other types of configurations.

The UID or data can include an associated user profile. For example, a first user profile can be associated with a first handlebar configuration and a second user profile can be associated with a second handlebar configuration. The first user profile can be stored within the data storage mechanism of a standard handlebar configuration. The second user profile can be stored within the data storage mechanism of a sport handlebar configuration. Additionally or alternatively, the UID can encode the user's settings associated with the handlebar 115 or bike 100 (e.g., the UID can include embedded information about the handlebar 115 or a user associated with the seat 110). The connector 112 of the handlebar 115 can transmit such data to the control system 150, or another portion of the bike 100, via the second connector 118 of the frame 120. For example, upon the handlebar connector 112 coupling with the second frame connector 118, the control system 150 can detect the identity and characteristics of the handlebar 115, which can be used to select or load a specific operating profile for the associated user. For example, the user profile can be associated with the user device 195 or with the user 190 having a predefined operating mode, as described herein. Other components of the system 90 can include similar or identical components including, but not limited to, wheels, lights, batteries, helmets associated with a user 190, among other components.

The user device 195 can include one or more applications that can transmit or receive data to or from the control system 150 of the bike 100. The user device 195 can communicate with the control system 150 through one or more pairing configurations including, for example, a QR code, handshake process, or another pairing process between the user device 195 and the control system 150. The user device 195 can include a unique identifier (UID) or a user profile associated with the user device 195 that can be linked to a specific operating mode of the bike 100, as described herein.

The third party device 185 can be or can include one or more devices of a third party (e.g., a third party entity). The third party device 185 can be or can include a computing device associated with a third party. The third party device 185 can include one or more identical or similar features as the user device 195 such that the control system 150 can communicate with the third party device 185.

The control system 150 (e.g., via the one or more processors 155) can limit or control one or more functions or capabilities of the bike 100 (e.g., a physical capability) based on various parameters received by the control system 150. For example, the control system 150 can generate and implement one or more different modes of operation (e.g., capabilities, parameters, functions of the propulsion system 148 or throttle 145, or communication between the propulsion system 148 and throttle 145) for the bike 100 based on various inputs or data received at the control system 150. For example, the control system 150 can limit or control a maximum or minimum speed, acceleration, torque, power, throttle capability, or other parameter (e.g., an out of box limitation) of the bike 100. For example, the control system 150 can geofence the bike 100 (e.g., use location data of the bike 100 to enforce virtual boundaries and automatically limit operation of the bike 100, such as preventing the bike 100 from physically traveling outside or exceeding preset limits within the boundaries). The control system 150 can adjust one or more actuators of the bike 100. For example, the bike 100 can include at least one actuator coupled to the seat 110 and at least one actuator coupled to the handlebars 115, among other actuators. The control system 150 can cause the one or more actuators to make an adjustment (e.g., cause the handlebar 115 or the seat 110 to move up, down, elongate, or shorten) to adjust a height, width, or other dimension of the bike 100. The control system 150 can cause an adjustment of suspension stiffness of the bike 100, an adjustment of suspension travel of the bike 100, an adjustment of lighting patterns of the bike 100, an adjustment of sounds of the bike 100, or an adjustment of a feature (e.g., theme, color, brightness, etc.) of a graphical user interface (GUI) of the bike 100 (e.g., via the display 170).

For example, the control system 150 can change, update, or modify signals communicated between the throttle 145 and the propulsion system 148 to switch an operating mode or condition of the bike 100. By way of example, the control system 150 can modify signals transmitted from the throttle 145 to the propulsion system 148 to modify or update how the propulsion system 148 responds to the signal. For example, in a first operating mode (e.g., a normal operating mode of the bike 100), an input to the throttle 145 can generate a signal to the propulsion system 148 to operate the bike 100 at a first speed (e.g., 30 mph). Responsive to determining an input to adjust an operating mode of the bike 100 (e.g., to a child-based operating mode as described herein), the control system 150 can modify the communication between the throttle 145 and the propulsion system 148 such that the input to the throttle 145 that would normally generate a signal to the propulsion system 148 to operate the bike 100 at a first speed (e.g., 30 mph) instead causes the propulsion system 148 to operate at a second speed in accordance with the selected or determined operating mode (e.g., less than the first speed, more than the first speed, etc.). This example is illustrative and the control system 150 can change or modify signals between the throttle 145 and the propulsion system 148 in various additional or alternative ways including, but not limited to, modifying acceleration signaling, torque signaling, or other modifications. By way of example, one or more of the modes of operation can include a mode of operation specific to the user 190 being a child or young adult to limit or regulate the child's usage of the bike 100, such as the speed or acceleration of the bike 100.

The control system 150 can generate or implement the one or more modes of operation for the bike 100 responsive to various inputs. For example, the control system 150 can implement a mode of operation responsive to receiving (e.g., via the communication interface 175) an indication of the user device 195 being within a threshold distance of the bike 100 (e.g., the communication interface 175 receiving one or more data from the user device 195 via NFC). With this configuration, the control system 150 can implement the mode (e.g., setting a maximum speed (e.g., 20 mph, 28 mph, etc.), acceleration, power output, turn signals, brightness of lights, time of use, location, or other condition of the bike 100 as described herein) when the user 190 having the user device 195 approaches or mounts the bike 100. For example, the control system 150 can identify (e.g., receive or pull) a unique identifier associated with the user device 195 and determine, based on the unique identifier, that the user device 195 is associated with a child or other user 190 associated with the mode of operation (e.g., via the unique identifier being associated with the mode of operation or a user profile having a mode of operation stored in the database 180).

The control system 150 can determine or implement one or more modes of operation of the bike 100 responsive to determining a metric associated with the battery 105 of the bike 100. For example, the battery 105 can include an identification stored within memory or other storage medium of the battery 105 (e.g., indicating that the battery 105 is a high-performance battery, a standard battery, or another type of battery). The control system 150 can adjust a characteristic of the bike 100 (e.g., a power output) based on the indication of the type of battery 105. For example, the control system 150 can adjust output based on the capabilities of the battery 105.

The modes of operation of the bike 100 can be predetermined or predefined. For example, the control system 150 can receive data from the user device 195 indicating various predetermined modes. For example, the user device 195 can include an application that can render a display to a user including a graphical user interface (GUI) for a user to select and set various parameters (e.g., speed limits, acceleration limits, usage limits, geographical/geofencing limits, mapping limits, time limits, parental override passcodes, etc.) and an identifier of a specific user device 195 or user 190 (e.g., user profiles or unique IDs including, but not limited to, equipment identifiers, IP/MAC addresses, serial numbers, universally unique identifiers, embedded identifiers, pins, passcodes, or other identifiers of a device or user) to be associated with a mode of operation. In some implementations, the control system 150 or the user device 195 can transmit the user profile or user unique identifier associated with the user 190 to another device (e.g., watch, ring, etc.). With this configuration, a user (e.g., a parent or guardian) could configure various modes for different children using the bike 100 remotely and can update or customize preset modes for various reasons (e.g., as a child grows). The system 90 can include a plurality of bikes 100 each having a control system 150 such that a user can generate and implement modes of operations for each of the plurality of bikes 100.

The control system 150 can implement a mode of operation responsive to receiving (e.g., via the communication interface 175) an input to the user device 195. For example, the input can include one or more manual user inputs to the user device 195, such as via a graphical user interface (GUI) indicating to operate the bike 100 at a predefined or specified mode of operation (e.g., via NFC or via network communication). For example, the user input can include a selection of a predefined mode, a selection of a newly defined mode, an identifier (e.g., passcode, pin number, etc.) associated with a mode, or various other user inputs.

The control system 150 can implement a mode of operation responsive to receiving an input to a portion of the control system 150, such as the display 170. For example, the display 170 can be or can include a touch screen or key pad disposed on the bike 100 such that the user 190 of the bike 100 can select a mode of operation of the bike 100 via the display 170. With this configuration, a user (e.g., a parent or guardian) could configure various modes for different children using the bike 100 remotely or via the bike 100 directly and can update or customize preset modes for various reasons (e.g., as a child grows).

The control system 150 can implement a mode of operation responsive to receiving a signal from one or more sensors. For example, various portions of the bike 100 (e.g., the seat 110, the handlebar 115, the frame 120, the drive train 135) can include various types of sensors that can detect the user 190 (e.g., a child). For example, the sensors can detect a weight, height, voice, or other characteristic of the user 190. The control system 150 can implement a mode of operation based on the characteristic of the user 190 meeting a threshold criteria.

The control system 150 can transmit various data or signals to a user device 195 based on a characteristic of the bike 100 or the user 190 of the bike 100 (e.g., location) while the bike 100 operates in a specific mode of operation. For example, one or more parameters of the mode of operation predefined (e.g., based on a specific location/jurisdiction of the bike 100) or defined by a user (e.g., via the user device 195 or via the display 170 of the bike 100 as described herein) can include indicators of specific locations, routes, distances (e.g., distance from a predetermined location), or other location data that sets a threshold location. For example, the control system 150 can use geofencing to detect a location of the bike 100 or the user device 195. Responsive to the control system 150 detecting the bike 100 (e.g., via GPS) or the user device 195 of the user 190 reaches a specific location or exceeds a threshold, the control system 150 can render an alert (e.g., pop-up notification, haptic, audio, or other alerts) via the display 170 of the bike 100 or to a second user device 195 (e.g., a guardian of the child using the bike 100). Additionally or alternatively, the bike 100 can turn off, slow down, or change routes responsive to exceeding a location threshold until the bike 100 moves within an allowed location. Similarly, the control system 150 can render an alert via the display 170 of the bike 100 or to a second user device 195 (e.g., a guardian of the child using the bike 100) responsive to the control system 150 determining the bike 100 is in use and associated with the user profile of the user 190 beyond a designated time period (e.g., designated curfew or shut-off time). In some implementations, the control system 150 can engage a wheel lock or seize a portion of the wheels 125 such that the wheels 125 cannot spin during a predefined time period associated with the operating mode (e.g., the bike 100 cannot operate between 9 pm-9 am, or another time period).

The control system 150 can maintain the bike 100 in a specific mode of operation until the control system 150 receives a signal or input indicating to switch modes or operate under standard operating conditions with no limits on speed, acceleration, or throttle control. For example, the control system 150 can switch modes or cease (e.g., stop) operating in a mode responsive to receiving a predefined passkey or pin from a user device 195 or via an input to the display 170 of the bike 100. The control system 150 can switch modes or cease operating in a mode responsive to receiving a physical interaction from, for example, a predefined user device 195 (e.g., a user, such as a parent, “tapping” a user device 195 to the display 170). The control system 150 can switch modes or cease operating in a mode responsive to operating the mode for a predefined period of time (e.g., 1 hour, after a specific time of day, etc.).

The control system 150 can change a condition of the propulsion system 148 responsive to determining the bike 100 is out of control or exceeds a threshold of an operating mode. For example, the control system 150 can receive a user input selecting to shut off the bike 100 or control another condition of the bike 100 (e.g., slow down) responsive to the bike 100 being outside of a threshold condition (e.g., speeding, accelerating too fast, etc.). By way of example, the control system 150 can determine the bike 100 is accelerating beyond a threshold limit as the bike 100 goes down a sloped hill or other surface. Responsive to determining the bike 100 is beyond a threshold limit, and that the operating mode includes a selection to slow the bike down beyond the threshold limit, the control system 150 can apply resistance via the propulsion system 148 to slow the bike down.

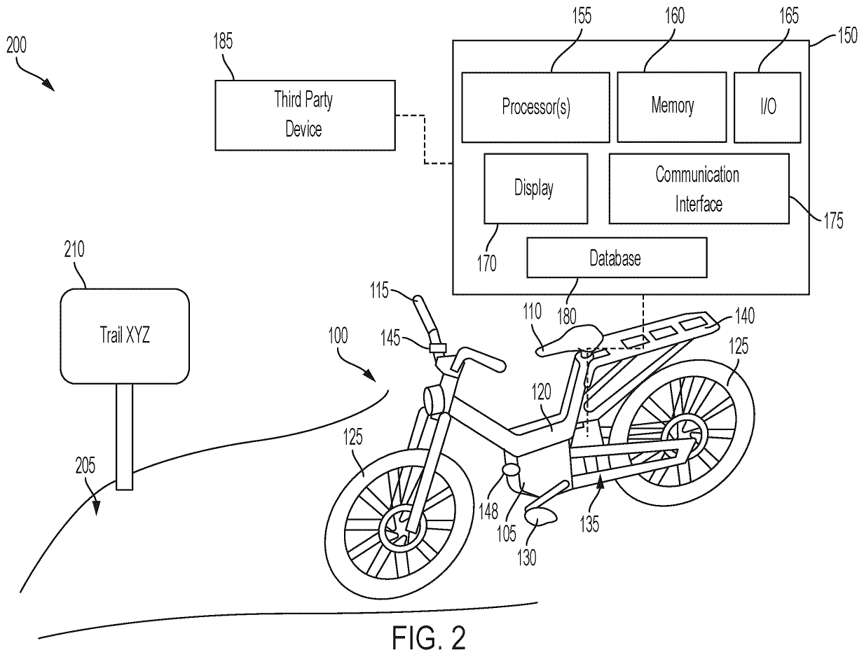

FIG. 2 depicts a schematic of a system 200, according to an example implementation. The system 200 can include, for example, a bicycle system 200. The system 200 can include one or more of the components of the system 90 of FIG. 1 including, but not limited to, the bike 100, the control system 150, the user 190, or the user device 195 (not depicted). The system 200 can include at least one trail 205. The trail 205 can include a surface for the bike 100 to travel (e.g., via the wheels 125 of the bike 100). For example, the trail 205 can be or can include a gravel trail, a paved trail (e.g., a road), a dirt trail, a wooded trail, or other types of trails or roads.

The database 180 of the control system 150 can store various information associated with the trail 205. For example, the database 180 can store trail information including, but not limited to, a trail location/map (e.g., GPS coordinates, geofencing information) and trail regulations (e.g., electronic bike limits based on class of bike, speed limits, time limits, or other regulations). While the database 180 is shown as part of the bike 100, the database 180 can be part of an external server or cloud system communicably coupled to the control system 150.

The control system 150 can receive the trail information through various ways. For example, the control system 150 can receive (e.g., via the communication interface 175) the trail information from the third party device 185. For example, the third party device 185 can be associated with one or more land managers or trail or park regulation entities (e.g., U.S. national park service, U.S. forest service, bureau of land management, state park entity, municipality entity, or other entities). The control system 150 can receive the trail information from the third party device 185 responsive to, for example, transmitting a request to the third party device 185 or pulling information from the third party device 185 via a website associated with or including details regarding the third party device 185 (e.g., via one or more web scraping techniques). The control system 150 can receive the trail information from the third party device 185 responsive to, for example, data mining information associated with the third party. The control system 150 can receive the trail information from the third party device 185 responsive to, for example, one or more user inputs to the database 180, or through various other ways.

The control system 150 can cross-reference the database 180 responsive to detecting the trail 205. For example, the control system 150 can detect the trail 205 through geofencing or other GPS/location information associated with the trail 205. For example, the control system 150 can automatically (e.g., continuously or cyclically) cross-reference a location of the bike 100 with the database 180 to determine whether the bike 100 reaches the trail 205 (e.g., based on location information of the trail matching the location of the bike 100).

Responsive to determining the bike 100 is at or near the trail 205, the control system 150 can identify any regulations associated with the trail and cause the display 170 to render the regulations to the user 190 or the bike 100, or the control system 150 can cause the bike 100 to operate in compliance with the identified regulations (e.g., via modifying communication between the throttle 145 and propulsion system 148 as described herein). For example, the control system 150 can cross reference the database 180 to determine that the trail 205 has a speed limit for e-bikes.

The control system 150 can cause the bike 100 to render an alert to the user 190 of the bike 100 of the speed limit or an indication that the bike 100 is exceeding the speed limit. For example, the control system 150 can generate light, haptic feedback (e.g., vibrations), noise, or the control system 150 can render the speed limit through the display 170 of the bike 100 with (or without) various lights, sounds, digital inks or screens, or other feedback to notify the user 190. In some implementations, if the user 190 of the bike 100 does not decrease the speed to below a speed limit threshold associated with the trail 205, the control system 150 can send additional alerts to the user 190 (e.g., via the display 170 or other feedback) continuously, cyclically, or via increasing increments. In some implementations, if the user 190 of the bike 100 does not decrease the speed to below a speed limit threshold associated with the trail 205, the control system 150 can automatically adjust the operating conditions of the bike 100, as described herein, to be in compliance with the regulations associated with the trail 205.

For example, the control system 150 can determine whether the bike 100 is in compliance with the identified regulations associated with the trail 205. For example, the bike 100 can detect a current speed of the bike 100 and compare the speed with an identified speed limit of the trail 205. If the current speed is exceeding the speed limit, the control system 150 can notify the user 190 about exceeding the speed limit in the ways described herein or through another way, or the control system 150 can cause the bike 100 to gradually slow down to comply with the speed limit (e.g., decreasing speed in increments, such as 1 mph per 30 seconds, or in other increments). The control system 150 can prompt a user 190 (e.g., via a display) to confirm to change an operating condition of the bike 100, or the control system 150 can automatically change an operating condition of the bike 100. The control system 150 can determine a speed limit based on an identified top/maximum classification or class of e-bikes (e.g., class 1, class 2, class 3) associated with the trail 205. The bike 100 can determine a speed limit for the bike 100 based on the class using information stored in the database 180 (e.g., class 1 speed limit may include 20 mph, class 2 speed limit may include 20 mph, class 3 speed limit may include 28 mph, etc.).

The control system 150 can receive or determine a regulation associated with the trail 205 through various additional or alternative ways such as, for example, bike-to-bike communications. For example, the control system 150 (e.g., via the communication interface 175) can receive a signal from a second bike 100 at or near the trail 205 indicating the speed limit of the trail 205 (or another parameter of the trail 205) or whether the user 190 is exceeding the speed limit. For example, another user of the second bike 100 can transmit a message to the bike 100 indicating the speed limit. Similarly, the control system 150 (e.g., via the communication interface 175) can transmit a signal from the bike 100 to the second bike 100 at or near the trail 205 indicating the speed limit of the trail 205 (or another parameter of the trail 205) or whether the secondary user of the second bike 100 is exceeding the speed limit. For example, the control system 150 can receive an input to the display 170 of the bike 100 indicating to transmit a message to one or more secondary displays 170 indicating the speed limit.

The control system 150 can receive or determine a regulation associated with the trail 205 through various additional or alternative ways such as, for example, receiving a signal from a node associated with the trail 205. For example, the trail 205 can include one or more markers 210 or other components associated with the trail 205 having or being a node. The control system 150 can scan and identify the node via the communication interface 175 responsive to the bike 100 being near or at the node (e.g., passing the marker 210).

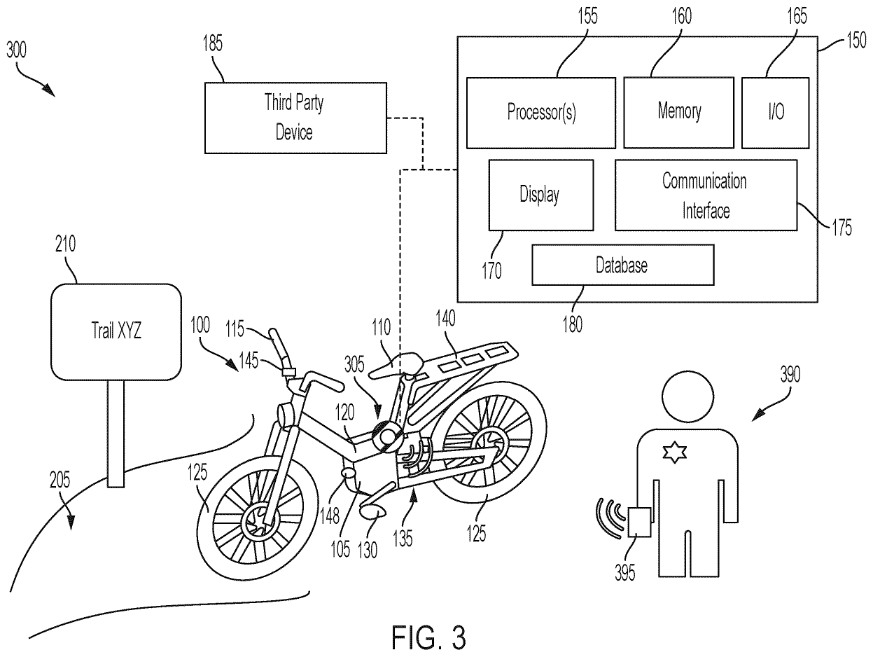

FIG. 3 depicts a schematic of a system 300, according to an example implementation. The system 300 can include, for example, a bicycle system 300. The system 300 can include one or more of the components of the systems 90, 200 of FIGS. 1 and 2 including, but not limited to, the bike 100, the control system 150, the trail 205, the marker 210, or the user 190/user device 195 (not depicted). The system 300 can include at least one third party 390. The third party 390 can be or can include various types of land enforcement, regulations, or security personnel including, but not limited to, park rangers, police officers, security offers, or other third parties. The system 300 can include at least one third party user device 395. The third party user device 395 can be similar in some ways to the user device 195. The at least one third party user device 395 can be or can include one or more devices capable of receiving various signals including, but not limited to, a receiver, a scanner, a cell phone, or various other devices.

The bike or other micromobility device 100 can include an indicator 305. The indicator 305 can couple with the bike 100. For example, the indicator 305 can be integrated (e.g., built into) one or more portions of the bike 100 (e.g., the frame 120, the seat 110, the wheels 125, the handlebar 115, the battery 105, or the rack 140). The indicator 305 can couple with the bike 100 through various other ways. For example, the indicator 305 can couple with the bike 100 through one or more fasteners, adhesives, welds, or other means. The indicator 305 can communicably couple with the control system 150.

The indicator 305 can include various features or components such that the indicator 305 is highly visible or detectable even from a distance of the bike 100 (e.g., 100 meters away, or further). For example, the indicator 305 can include one or more lights that are visible along an exterior of the bike 100. The indicator 305 can include one or more audio features that produce noise from the indicator 305 (e.g., a speaker). The indicator 305 can include one or more transmitters or transponders that can transmit a signal to, for example, the third party user device 395.

The indicator 305 can communicably couple with the control system 150 such that the indicator 305 and the control system 150 can send or receive data between one another. For example, the control system 150 can transmit a signal to the indicator 305 to cause the indicator 305 to produce a detectable characteristic (e.g., a light or flashing light, digital ink using electrophoresis, a sound, or a transmission of a signal). For example, the control system 150 can transmit a signal to the indicator 305 to cause the indicator 305 to produce a detectable characteristic responsive to the control system 150 operating in a specific operating mode, condition, or at a particular speed or power of the bike 100. For example, the bike 100 (e.g., based on the control system 150) can operate in accordance with a class of the bike 100 (e.g., class 1, class 2, class 3 described herein). The bike 100 (e.g., based on the control system 150) can switch operating modes based on, for example, class characteristics. For example, the control system 150 can cause the bike 100 to switch from operating in accordance with a class 3 bike to a class 1 bike. The control system 150 can transmit a signal to the indicator 305 to cause the indicator 305 to produce a detectable characteristic indicating the change in class or mode. For example, the indicator 305 can flash a specific color light associated with the class or operation mode (e.g., class 1 or traveling at a speed under 20 mph is associated with a green light, class 2 or traveling at a speed under 20 mph is associated with a yellow light, class 2 or traveling at a speed under 20 mph is associated with a yellow light). This is for illustrative purposes. The indicator 305 can flash different colored light or noises based on the operating mode of the bike 100. For example, the indicator 305 can indicate (e.g., via light, audio, video, or text), that the bike 100 is in a certain operating mode, such as a child mode.

The control system 150 can cause the indicator 305 to produce a detectable characteristic indicating the change in class or mode for a predetermined period of time, or based on a location or signal detected by the control system 150. For example, the control system 150 can cause the indicator 305 to produce a detectable characteristic indicating the change in class or mode for a predetermined period of time when the control system 150 changes a mode of operation or class of the bike 100. As another example, the control system 150 can cause the indicator 305 to produce a detectable characteristic indicating the change in class or mode responsive to detecting a location of the bike 100 (e.g., at the start or end of the trail 205). As another example, the control system 150 can cause the indicator 305 to produce a detectable characteristic indicating the change in class or mode responsive to detecting the third party user device 395. For example, responsive to detecting the third party user device 395 (e.g., by receiving a signal from the third party user device 395), the control system 150 can cause the indicator 305 to produce a detectable characteristic indicating the change in class or mode for a predetermined period of time. This facilitates allowing the at least one third party 390 to readily view and assess the operating mode of the bike 100 while reducing power of the bike 100 (e.g., by only displaying the characteristic via the indicator 305 for a period of time or at a specific location) while reducing unnecessary stoppage of the bike 100 to evaluate the operating mode of the bike 100.

The indicator 305 can be static or non-static. For example, the indicator 305 can constantly display the detectable characteristic, the indicator 305 can intermittently display the detectable characteristic, or the indicator 305 can intermittently display a plurality (e.g., combination or pattern) of detectable characteristics. The indicator 305 can be programmable. For example, the control system 150 can receive one or more inputs (e.g., via the display 170 or via the user device 195) selecting or defining a status of the indicator based on the operating mode of the bike 100. The control system 150 can receive one or more inputs (e.g., via the display 170 or via the user device 195) that cause the control system 150 to cause the indicator 305 to display the detectable characteristic. For example, the display 170 can receive a user input indicating to display the detectable characteristic responsive to the user 190 seeing, for example, the third party 390.

A method can include providing the control system 150 to control a characteristic of the bike 100. The method can include providing the indicator 305 to produce a detectable characteristic. The method can include causing, by the control system, the indicator 305 to produce the detectable characteristic responsive to the control system 150 changing the characteristic (e.g., class or operating mode) of the bike 100. The method can include causing, by the control system 150, the indicator 305 to produce the detectable characteristic for a predetermined period of time.

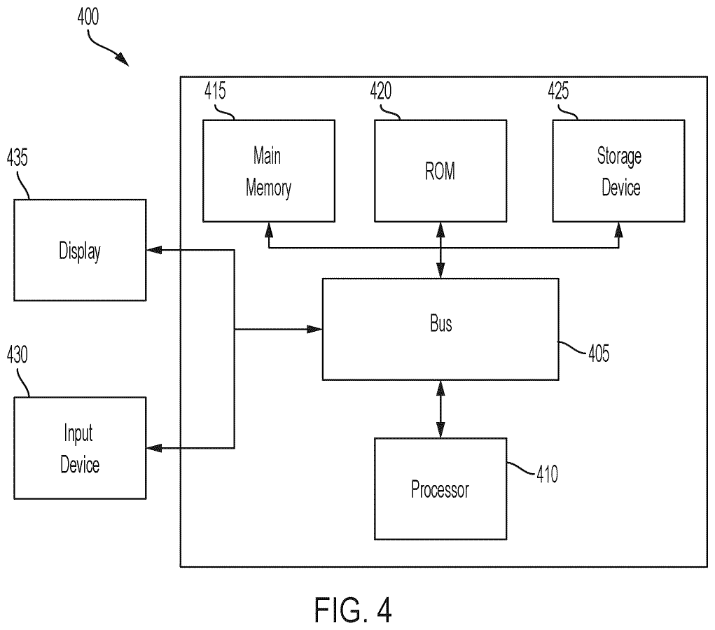

FIG. 4 is a block diagram illustrating an architecture for a computer system 400 that can be employed to implement elements of the systems and methods described and illustrated herein, including, for example, the control system 150 depicted in FIGS. 1-3. For example, the control system 150 can be or include the computing system 400. The computing system 400 can include at least one bus 405 or other communication component for communicating information and at least one processor 410 or processing circuit coupled to the bus 405 for processing information. The computing system 400 can also include one or more processors 410 or processing circuits coupled to the bus for processing information. The computing system 400 also includes at least one main memory 415, such as a random access memory (RAM) or other dynamic storage device, coupled to the bus 405 for storing information, and instructions to be executed by the processor 410. The main memory 415 can be used for storing information during execution of instructions by the processor 410. The computing system 400 may further include at least one read only memory (ROM) 420 or other static storage device coupled to the bus 405 for storing static information and instructions for the processor 410. A storage device 425, such as a solid state device, magnetic disk or optical disk, can be coupled to the bus 405 to persistently store information and instructions.

The computing system 400 may be coupled via the bus 405 to a display 435, such as a liquid crystal display, or active matrix display, for displaying information to a user 190 such as a rider of the bike 100 or other end user. An input device 430, such as a keyboard or voice interface may be coupled to the bus 405 for communicating information and commands to the processor 410. The input device 430 can include a touch screen display 435. The input device 430 can also include a cursor control, such as a mouse, a trackball, or cursor direction keys, for communicating direction information and command selections to the processor 410 and for controlling cursor movement on the display 435.

The processes, systems and methods described herein can be implemented by the computing system 400 in response to the processor 410 executing an arrangement of instructions contained in main memory 415. Such instructions can be read into main memory 415 from another computer-readable medium, such as the storage device 425. Execution of the arrangement of instructions contained in main memory 415 causes the computing system 400 to perform the illustrative processes described herein. One or more processors in a multi-processing arrangement may also be employed to execute the instructions contained in main memory 415. Hard-wired circuitry can be used in place of or in combination with software instructions together with the systems and methods described herein. Systems and methods described herein are not limited to any specific combination of hardware circuitry and software.

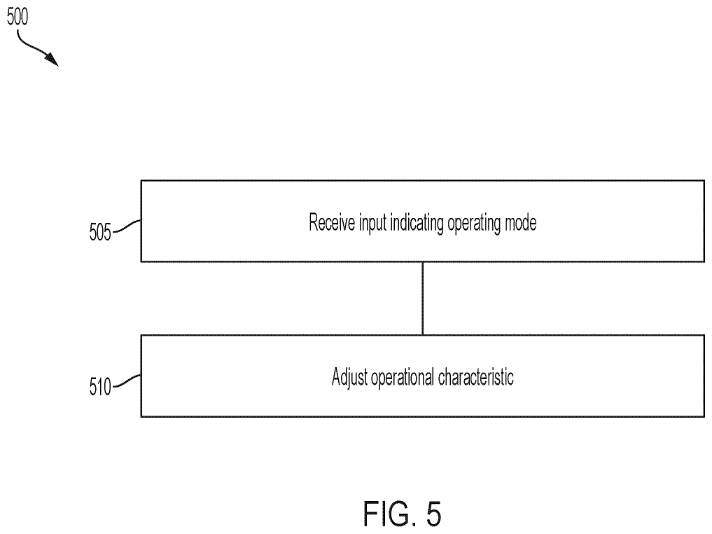

FIG. 5 depicts a method 500 of operating the bike or other micromobility device 100, according to an example implementation. The method 500 can include communicably coupling the control system 150 with the propulsion system 148 and throttle 145 to control a characteristic (e.g., speed, power, torque, etc.) of the propulsion system 148. The method 500 can include receiving, by the control system 150, an input indicating a selection of an operating mode of the propulsion system 148, as depicted in act 505. For example, the input can be or can include an identifier associated with a user device 195 of a user 190 (e.g., responsive to the control system 150 pulling or detecting an indication of the user device 195 near the bike 100 via the communication interface 175). The input can include a user input to the user device 195 (e.g., the user device 195 receiving a pin number associated with a user profile or a selection or an operating mode). The input can be or can include a manual input to a display of the bike 100 (e.g., a user input to a touchscreen or key pad selecting an operating mode). The input can be or can include a connector 116, 118 of the frame 120 receiving a replaceable component, such as a seat 110, a handlebar 115, a seat 110, or another component.

The method 500 can include adjusting, by the control system 150, the operational characteristic of the propulsion system 148 or throttle 145 based on the selection of the operating mode, as depicted in act 510. For example, the control system 150 can change, update, or modify signals communicated between the throttle 145 and the propulsion system 148. By way of example, the control system 150 can modify signals transmitted from the throttle 145 to the propulsion system 148 to modify or update how the propulsion system 148 responds to the signal. For example, in a first operating mode (e.g., a normal operating mode of the bike 100), an input to the throttle 145 can generate a signal to the propulsion system 148 to operate the bike 100 at a first speed (e.g., 30 mph). Responsive to determining an input to adjust an operating mode of the bike 100 (e.g., to a child-based operating mode), the control system 150 can modify the communication between the throttle 145 and the propulsion system 148 such that the input to the throttle 145 that would generate a signal to the propulsion system 148 to operate the bike 100 at a first speed (e.g., 30 mph) causes the propulsion system 148 to operate at a second speed in accordance with the selected or determined operating mode (e.g., less than 30 mph). This example is illustrative and the control system 150 can change or modify signals between the throttle 145 and the propulsion system 148 in various additional or alternative ways including, but not limited to, a change in acceleration, a change in torque, or other modifications. While communication between the propulsion system 148 and the throttle 145 is described, the control system 150 can additionally or alternatively modify communication between the propulsion system 148 and various other switches or user inputs of the bike 100 to modify the operating mode of the bike 100.

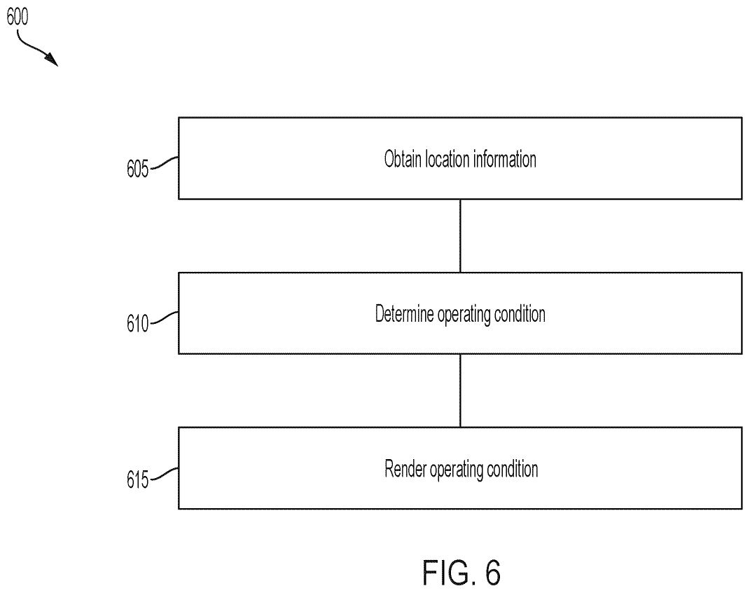

FIG. 6 depicts a method 600 of operating the bike or other micromobility device 100, according to an example implementation. The method 600 can include coupling the control system 150 with the display 170 of the bike 100. The method 600 can include obtaining, by the control system 150, a location of the bike 100, as depicted in act 605. For example, the control system 150 can receive, detect, or obtain a location of the bike 100 via on onboard sensor of the bike 100 (e.g., via a location sensor having a GPS receiver configured to determine a geographic position of the bike 100). Based on the location information of the bike 100, the control system 150 can determine the bike 100 has reached a trail 205. For example, the control system 150 can automatically (e.g., continuously or cyclically) cross-reference a location of the bike 100 with the database 180 to determine whether the bike 100 reaches the trail 205 (e.g., based on location information of the trail matching the location of the bike 100).

The control system 150 can detect the bike 100 has reached or entered a location of a trail 205 through geofencing or other GPS/location information associated with the trail 205. The control system 150 (e.g., via the communication interface 175) can receive a signal from a second bike 100 at or near the trail 205 indicating the bike 100 has reached a trail 205. For example, another user of the second bike 100 can transmit a message to the bike 100 indicating the bike 100 has reached a trail 205. The control system 150 can detect the trail 205 via one or more markers 210 or other components associated with the trail 205 having or being a node. The control system 150 can scan and identify the node via the communication interface 175 responsive to the bike 100 being near or at the node (e.g., passing the marker 210).

The method 600 can include determining, by the control system 150, based on the location information, a corresponding operating condition (e.g., speed limit) of the bike 100, as depicted in act 610. For example, responsive to determining the bike 100 is at or near the trail 205, the control system 150 can identify any regulations associated with the trail 205. For example, the control system 150 can cross reference the database 180 to determine that the trail 205 has a speed limit for e-bikes. For example, the method 600 can include comparing the location of the bike 100 with a plurality of regions (e.g., trails or other regions) having device limitations (e.g., speed limit or other regulations described herein) or other regulations associated with the region. The method 600 can determining a corresponding operating condition of the propulsion system 148 (e.g., speed limit, acceleration limit, or other condition described herein) based on the device limitations associated with the region.

The method 600 can include applying, by the control system 150, the corresponding operating condition to the propulsion system 148 while the bike 100 is within the region. For example, as long as the bike 100 remains on the trail 205 (e.g., based on the control system 150 determining that the location of the bike matches the location of the trail 205 by continuously tracking the bike's location via the onboard sensor), the control system 150 can cause the propulsion system 148 to operate based on the device limitations associated with the trail 205, as described herein.

For example, the bike 100 can detect a current speed of the bike 100 and compare the speed with an identified speed limit of the trail 205. If the current speed is exceeding the speed limit, the control system 150 can notify the user 190 about exceeding the speed limit in the ways described herein or through another way, or the control system 150 can cause the bike 100 to gradually slow down to comply with the speed limit (e.g., decreasing speed in increments, such as 1 mph per 30 seconds, or in other increments). The control system 150 can prompt a user 190 (e.g., via a display) to confirm to change an operating condition of the bike 100, or the control system 150 can automatically change an operating condition of the bike 100. The control system 150 can determine a speed limit based on an identified top/maximum classification or class of e-bikes (e.g., class 1, class 2, class 3) associated with the trail 205. The bike 100 can determine a speed limit for the bike 100 based on the class using information stored in the database 180 (e.g., class 1 speed limit may include 20 mph, class 2 speed limit may include 20 mph, class 3 speed limit may include 28 mph, etc.).

The method 600 can include causing, by the control system 150, the display 170 to render the corresponding operating condition to the user 190 of the bike 100, as depicted in act 615. For example, the control system 150 can cause the bike 100 to render an alert to the user 190 of the bike 100 of the speed limit or whether the bike 100 is exceeding the speed limit. The control system 150 can generate light, haptic feedback (e.g., vibrations), noise, or the control system 150 can render the speed limit through the display 170 of the bike 100 with (or without) various lights, sounds, digital inks or screens, or other feedback to notify the user 190. In some implementations, if the user 190 of the bike 100 does not decrease the speed to below a speed limit threshold associated with the trail 205, the control system 150 can send additional alerts to the user 190 (e.g., via the display 170 or other feedback) continuously, cyclically, or via increasing increments. In some implementations, if the user 190 of the bike 100 does not decrease the speed to below a speed limit threshold associated with the trail 205, the control system 150 can automatically adjust the operating conditions of the bike 100, as described herein, to be in compliance with the regulations associated with the trail 205.

The control system 150 can receive or determine a regulation associated with the trail 205 through various additional or alternative ways such as, for example, bike-to-bike communications. For example, the control system 150 (e.g., via the communication interface 175) can receive a signal from a second bike 100 at or near the trail 205 indicating the speed limit of the trail 205 (or another parameter of the trail 205) or whether the user 190 is exceeding the speed limit. For example, another user of the second bike 100 can transmit a message to the bike 100 indicating the speed limit. Similarly, the control system 150 (e.g., via the communication interface 175) can transmit a signal from the bike 100 to the second bike 100 at or near the trail 205 indicating the speed limit of the trail 205 (or another parameter of the trail 205) or whether the secondary user of the second bike 100 is exceeding the speed limit. For example, the control system 150 can receive an input to the display 170 of the bike 100 indicating to transmit a message to one or more secondary displays 170 indicating the speed limit.

In various embodiments, the micromobility device 100 may be designed to support a gross vehicle weight, defined as the combined mass of the device, rider, payload, and accessories, which corresponds to applicable regulatory or industry standards for micromobility devices. By way of example and without limitation, certain bicycle-based and electric bicycle standards, such as ISO 4210 and EN 15194, contemplate testing and design assumptions for a total mass on the order of approximately 120 kilograms, inclusive of rider and load, while other micromobility categories, including scooters, mopeds, and cargo-oriented devices, may be designed for higher gross vehicle weights, such as greater than 120 kilograms, greater than 150 kilograms, or greater than 200 kilograms, depending on jurisdiction, classification, and intended use. In some embodiments, the micromobility device 100 may be configured to comply with regulations and testing protocols, such as those administered by the U.S. Consumer Product Safety Commission, which may specify structural strength, braking performance, and fatigue testing criteria corresponding to representative rider and payload masses. References to such weight values are intended to reflect regulatory examples rather than to impose fixed design limits on the disclosed embodiments.

The propulsion system 148 may include an electric motor, a human-powered drivetrain, or a combination thereof, and may be configured in hub-based, mid-mounted, or remote arrangements using chain, belt, shaft, gear, friction, or direct-drive mechanisms to transmit torque to at least one ground-engaging element. An energy storage system may be provided to store electrical energy for powering the propulsion system 148 and auxiliary components, and may include one or more batteries, capacitors, fuel cells, or other energy storage technologies that may be removable, fixed, swappable, or distributed across multiple locations on the device. The energy storage system may further include charging circuitry, battery management systems, thermal management components, and monitoring elements configured to meet or exceed applicable electrical standards for micromobility devices, including but not limited to UL 2849, UL 2272, IEC 62133, or equivalent regional or international standards.

The micromobility device 100 may further include a control system 150 comprising one or more processors, controllers, sensors, and communication interfaces configured to manage propulsion output, braking behavior, energy usage, and auxiliary functions. The control system 150 may regulate motor output based on rider input, operating conditions, load, speed, inclination, or environmental sensing, and may support software-based features such as diagnostics, data logging, fleet management integration, geofencing, or over-the-air software updates. Braking systems may include mechanical, hydraulic, electromagnetic, regenerative, or combined braking mechanisms, and the device may further include stability or features such as traction control, anti-lock braking, suspension systems, steering dampening elements, lighting systems, and audible warning devices. In various embodiments, the micromobility device 100 may be designed to comply with applicable operational and mechanical standards, including but not limited to ISO 4210, EN 15194, SAE J3194, applicable portions of 16 CFR Part 1512, and corresponding regional, national, or municipal micromobility regulations governing speed, power output, braking performance, lighting, and gross vehicle weight classifications.

The micromobility device 100 may include a rider interface configured to receive user input through handlebars, grips, pedals, throttles, buttons, touch interfaces, or gesture-based controls, and may alternatively or additionally include a payload interface configured to support cargo, delivery containers, child seats, or autonomous payload modules. In some embodiments, the micromobility device 100 may be configured as, or convertible between, multiple micromobility form factors, including electric bicycles, scooters, mopeds, seated or standing ride-on devices, or cargo and utility vehicles, wherein such configurations may share common components or differ only in selected structural, propulsion, control, or interface elements. Unless otherwise stated, the components and features described herein may be combined, omitted, rearranged, scaled, or substituted without departing from the scope of the disclosure, and references to regulatory standards or weight limits are intended to be exemplary and non-limiting.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer-based components.

The systems described above can provide multiple ones of any or each of those components and these components can be provided on either a standalone system or on multiple instantiations in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C #, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device,” “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. For example, references to a bike or bicycle include references to any micromobility device, and vice-versa. In particular, and although many of the examples presented herein involve specific combinations of method acts or system elements, those acts and those elements may be combined in other ways to accomplish the same objectives. Acts, elements, and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A,’ only ‘B,’ as well as both ‘A’ and ‘B.’ Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

A micromobility device can include a propulsion system and a control system communicably coupled to the propulsion system. The control system can detect a user device within a threshold distance of the micromobility device, determine, based on the user device, an operating mode of the propulsion system, receive, via a throttle, a user input to the throttle, modify a signal associated with the user input to the throttle based on the operating mode, and cause the propulsion system to adjust an operating condition of the propulsion system based on the modified signal. The micromobility device can include a frame including a first connector and a replaceable component including a second connector and storage including a unique identifier. The first connector is configured to receive the second connector. The control system is configured to determine, based on the unique identifier of the replaceable component, a configuration of the replaceable component. The configuration of the replaceable component defines the operating mode. The replaceable component includes at least one of a seat or a handlebar. The micromobility device is an electric bicycle.

A micromobility device can include a propulsion system and a control system communicably coupled to the propulsion system. The control system can detect a user device within a threshold distance of the micromobility device, determine, based on the user device, an operating mode of the propulsion system, receive, via a throttle, a user input to the throttle, modify a signal associated with the user input to the throttle based on the operating mode, and cause the propulsion system to adjust an operating condition of the propulsion system based on the modified signal. The micromobility device can include a frame including a first connector and a replaceable component including a second connector and storage including a unique identifier. The first connector is configured to receive the second connector. The control system is configured to determine, based on the unique identifier of the replaceable component, a configuration of the replaceable component. The configuration of the replaceable component defines the operating mode. The control system is configured to obtain, from the detected user device, a unique identifier associated with the user device and the unique identifier defines the operating mode. The operating condition of the propulsion system includes at least one of a speed limit, an acceleration limit, a time limit, a distance limit, or a power output limit.

A micromobility device can include a propulsion system and a control system communicably coupled to the propulsion system. The control system can detect a user device within a threshold distance of the micromobility device, determine, based on the user device, an operating mode of the propulsion system, receive, via a throttle, a user input to the throttle, modify a signal associated with the user input to the throttle based on the operating mode, and cause the propulsion system to adjust an operating condition of the propulsion system based on the modified signal. The control system is configured to obtain, from the detected user device, a unique identifier associated with the user device and the unique identifier defines the operating mode. The operating condition of the propulsion system includes at least one of a speed limit, an acceleration limit, a time limit, a distance limit, or a power output limit.

A control system can include one or more processors. The one or more processors can detect a user device within a threshold distance of the micromobility device, determine, based on the user device, an operating mode of a propulsion system of the micromobility device, receive, via a throttle of the micromobility device, a user input to the throttle, modify a signal associated with the user input to the throttle based on the operating mode, and cause the propulsion system to adjust an operating condition of the propulsion system based on the modified signal. The one or more processors are configured to detect, via a first connector of a frame of the micromobility device, that the first connector receives a second connector of a replaceable component, receive, via the replaceable component, a unique identifier of the replaceable component, determine, based on the unique identifier, a configuration of the replaceable component, and determine, based on the configuration of the replaceable component, the operating mode. The replaceable component includes at least one of a seat or a handlebar. The micromobility device is an electric bicycle.

A control system can include one or more processors. The one or more processors can detect a user device within a threshold distance of the micromobility device, determine, based on the user device, an operating mode of a propulsion system of the micromobility device, receive, via a throttle of the micromobility device, a user input to the throttle, modify a signal associated with the user input to the throttle based on the operating mode, and cause the propulsion system to adjust an operating condition of the propulsion system based on the modified signal. The operating condition of the propulsion system including at least one of a speed limit, an acceleration limit, a time limit, a distance limit, or a power output limit.

A control system can include one or more processors. The one or more processors can detect a user device within a threshold distance of the micromobility device, determine, based on the user device, an operating mode of a propulsion system of the micromobility device, receive, via a throttle of the micromobility device, a user input to the throttle, modify a signal associated with the user input to the throttle based on the operating mode, and cause the propulsion system to adjust an operating condition of the propulsion system based on the modified signal. The one or more processors are configured to receive a passkey from the user device, the passkey indicating a selection of a second operating mode and cause the propulsion system to adjust the operating condition of the propulsion system based on the second operating mode.

A method can include detecting, by a control system of a micromobility device, a user device within a threshold distance of the micromobility device. The method can include determining, by the control system, based on the user device, an operating mode of a propulsion system of the micromobility device. The method can include receiving, by the control system, via a throttle of the micromobility device, a user input to the throttle. The method can include modifying, by the control system, a signal associated with the user input to the throttle based on the operating mode. The method can include causing, by the control system the propulsion system to adjust an operating condition of the propulsion system based on the modified signal. The method includes detecting, by the control system, via a first connector of a frame of the micromobility device, that the first connector receives a second connector of a replaceable component, receiving, by the control system, via the replaceable component, a unique identifier of the replaceable component, determining, by the control system, based on the unique identifier, a configuration of the replaceable component; and determining, by the control system, based on the configuration of the replaceable component, the operating mode. The replaceable component includes at least one of a seat or a handlebar.

A method can include detecting, by a control system of a micromobility device, a user device within a threshold distance of the micromobility device. The method can include determining, by the control system, based on the user device, an operating mode of a propulsion system of the micromobility device. The method can include receiving, by the control system, via a throttle of the micromobility device, a user input to the throttle. The method can include modifying, by the control system, a signal associated with the user input to the throttle based on the operating mode. The method can include causing, by the control system the propulsion system to adjust an operating condition of the propulsion system based on the modified signal. The method includes obtaining, by the control system, from the detected user device, a unique identifier associated with the user device. The unique identifier defines the operating mode.

A micromobility device can include a propulsion system and a control system communicably coupled with the propulsion system. The control system can determine, via an onboard sensor, a location of the micromobility device, compare the location to a region having device limitations, determine a corresponding operating condition of the propulsion system associated with the device limitations, and apply the corresponding operating condition to the propulsion system while the micromobility device is within the region. The control system is configured to receive, via a throttle, a user input to the throttle, modify a signal associated with the user input to the throttle, transmit the modified signal to the propulsion system, and apply the corresponding operating condition of the propulsion system based on the modified signal. The control system is configured to automatically cross-reference the location of the micromobility device with a database to determine the location is within the region. The database includes a plurality of operating conditions associated with a plurality of regions.

A micromobility device can include a propulsion system and a control system communicably coupled with the propulsion system. The control system can determine, via an onboard sensor, a location of the micromobility device, compare the location to a region having device limitations, determine a corresponding operating condition of the propulsion system associated with the device limitations, and apply the corresponding operating condition to the propulsion system while the micromobility device is within the region. The control system is configured to receive, via a throttle, a user input to the throttle, modify a signal associated with the user input to the throttle, transmit the modified signal to the propulsion system, and apply the corresponding operating condition of the propulsion system based on the modified signal. The location defines a trail and the corresponding operating condition includes a speed limit associated with the trail.

A control system can include one or more processors. The one or more processors can determine, via an onboard sensor of the micromobility device, a location of the micromobility device, compare the location to a region having device limitations, determine a corresponding operating condition of a propulsion system of the micromobility device associated with the device limitations, and apply the corresponding operating condition to the propulsion system while the micromobility device is within the region. The one or more processors are configured to receive, via a throttle, a user input to the throttle, modify a signal associated with the user input to the throttle, transmit the modified signal to the propulsion system, and apply the corresponding operating condition of the propulsion system based on the modified signal. The one or more processors are configured to automatically cross-reference the location of the micromobility device with a database to determine the location is within the region, and the database includes a plurality of operating conditions associated with a plurality of regions.

A control system can include one or more processors. The one or more processors can determine, via an onboard sensor of the micromobility device, a location of the micromobility device, compare the location to a region having device limitations, determine a corresponding operating condition of a propulsion system of the micromobility device associated with the device limitations, and apply the corresponding operating condition to the propulsion system while the micromobility device is within the region. The one or more processors are configured to receive, via a throttle, a user input to the throttle, modify a signal associated with the user input to the throttle, transmit the modified signal to the propulsion system, and apply the corresponding operating condition of the propulsion system based on the modified signal. The location defines a trail and the corresponding operating condition includes a speed limit associated with the trail. The one or more processors are configured to render the corresponding operating condition on a display.

A method can include determining, by a control system of a micromobility device, a location of the micromobility device. The method can include comparing, by the control system, the location to a region having device limitations. The method can include determining, by the control system, a corresponding operating condition of a propulsion system of the micromobility device associated with the device limitations. The method can include applying, by the control system, the corresponding operating condition to the propulsion system while the micromobility device is within the region. The method includes receiving, by the control system, via a throttle, a user input to the throttle, modifying, by the control system, a signal associated with the user input to the throttle, transmitting, by the control system, the modified signal to the propulsion system, and applying, by the control system, the corresponding operating condition of the propulsion system based on the modified signal. The location defines a trail and the corresponding operating condition includes a speed limit associated with the trail.

A method can include determining, by a control system of a micromobility device, a location of the micromobility device. The method can include comparing, by the control system, the location to a region having device limitations. The method can include determining, by the control system, a corresponding operating condition of a propulsion system of the micromobility device associated with the device limitations. The method can include applying, by the control system, the corresponding operating condition to the propulsion system while the micromobility device is within the region. The method includes receiving, by the control system, via a throttle, a user input to the throttle, modifying, by the control system, a signal associated with the user input to the throttle, transmitting, by the control system, the modified signal to the propulsion system, and applying, by the control system, the corresponding operating condition of the propulsion system based on the modified signal. The method includes automatically cross-referencing, by the control system, the location of the micromobility device with a database to determine the location is within the region. The database includes a plurality of operating conditions associated with a plurality of regions. The method includes causing, by the control system, an indicator to produce a detectable characteristic responsive to the application of the corresponding operating condition of the propulsion system.

1. A micromobility device, comprising:
a propulsion system; and
a control system communicably coupled to the propulsion system, the control system configured to:
detect a user device within a threshold distance of the micromobility device;
determine, based on the user device, an operating mode of the propulsion system;
receive, via a throttle, a user input to the throttle;
modify a signal associated with the user input to the throttle based on the operating mode; and
cause the propulsion system to adjust an operating condition of the propulsion system based on the modified signal.

2. The micromobility device of claim 1, comprising:
a frame, the frame including a first connector;
a replaceable component, the replaceable component including a second connector and storage including a unique identifier;
the first connector configured to receive the second connector;
the control system configured to determine, based on the unique identifier of the replaceable component, a configuration of the replaceable component; and
the configuration of the replaceable component defining the operating mode.

3. The micromobility device of claim 2, wherein the replaceable component comprises at least one of a seat or a handlebar.

4. The micromobility device of claim 1, comprising:
the control system configured to obtain, from the detected user device, a unique identifier associated with the user device; and
the unique identifier defining the operating mode.

5. The micromobility device of claim 1, comprising:
the operating condition of the propulsion system including at least one of a speed limit, an acceleration limit, a time limit, a distance limit, or a power output limit.

6. The micromobility device of claim 1, comprising:
the control system configured to receive a passkey from the user device, the passkey indicating a selection of a second operating mode; and
the control system configured to cause the propulsion system to adjust the operating condition of the propulsion system based on the second operating mode.

7. The micromobility device of claim 1, wherein the micromobility device comprises an electric bicycle.

8. A control system for a micromobility device, comprising:
one or more processors configured to:
detect a user device within a threshold distance of the micromobility device;
determine, based on the user device, an operating mode of a propulsion system of the micromobility device;
receive, via a throttle of the micromobility device, a user input to the throttle;
modify a signal associated with the user input to the throttle based on the operating mode; and
cause the propulsion system to adjust an operating condition of the propulsion system based on the modified signal.

9. The control system of claim 8, wherein the one or more processors are configured to:
detect, via a first connector of a frame of the micromobility device, that the first connector receives a second connector of a replaceable component;
receive, via the replaceable component, a unique identifier of the replaceable component;
determine, based on the unique identifier, a configuration of the replaceable component; and
determine, based on the configuration of the replaceable component, the operating mode.

10. The control system of claim 9, wherein the replaceable component comprises at least one of a seat or a handlebar.

11. The control system of claim 8, wherein the one or more processors are configured to:
obtain, from the detected user device, a unique identifier associated with the user device; and
wherein the unique identifier defines the operating mode.

12. The control system of claim 8, comprising:
the operating condition of the propulsion system including at least one of a speed limit, an acceleration limit, a time limit, a distance limit, or a power output limit.

13. The control system of claim 8, wherein the one or more processors are configured to:
receive a passkey from the user device, the passkey indicating a selection of a second operating mode; and
cause the propulsion system to adjust the operating condition of the propulsion system based on the second operating mode.

14. The control system of claim 8, wherein the micromobility device comprises an electric bicycle.

15. A method, comprising:
detecting, by a control system of a micromobility device, a user device within a threshold distance of the micromobility device;
determining, by the control system, based on the user device, an operating mode of a propulsion system of the micromobility device;
receiving, by the control system, via a throttle of the micromobility device, a user input to the throttle;
modifying, by the control system, a signal associated with the user input to the throttle based on the operating mode; and
causing, by the control system, the propulsion system to adjust an operating condition of the propulsion system based on the modified signal.

16. The method of claim 15, comprising:
detecting, by the control system, via a first connector of a frame of the micromobility device, that the first connector receives a second connector of a replaceable component;
receiving, by the control system, via the replaceable component, a unique identifier of the replaceable component;
determining, by the control system, based on the unique identifier, a configuration of the replaceable component; and
determining, by the control system, based on the configuration of the replaceable component, the operating mode.

17. The method of claim 16, wherein the replaceable component comprises at least one of a seat or a handlebar.

18. The method of claim 15, comprising:
obtaining, by the control system, from the detected user device, a unique identifier associated with the user device; and
wherein the unique identifier defines the operating mode.

19. The method of claim 15, comprising:
the operating condition of the propulsion system including at least one of a speed limit, an acceleration limit, a time limit, a distance limit, or a power output limit.

20. The method of claim 15, wherein the micromobility device comprises an electric bicycle.

21.-40. (canceled)
